(19) United States
(12) Patent Application Publication
(10) Pub. No.: US 2015/0177602 A1
(43) Pub. Date: Jun. 25, 2015

(54) LIGHT SOURCE APPARATUS AND ELECTRONIC EQUIPMENT

(71) Applicants: Yusuke Tani, Tokyo (JP); Yoshinobu Moriya, Tokyo (JP)

(72) Inventors: Yusuke Tani, Tokyo (JP); Yoshinobu Moriya, Tokyo (JP)

(21) Appl. No.: 14/416,270

(22) PCT Filed: Sep. 14, 2012
(86) PCT No.: PCT/JP2012/073704

§ 371 Date: Jan. 21, 2015

(51) Int. Cl. G03B 21/16; F21V 33/00; G03B 21/20; F21V 13/10

(52) U.S. Cl. CPC G03B 21/16; F21V 13/10; F21V 33/0052; G03B 21/2066; G03B 21/2053; F21W 2131/40

(57) ABSTRACT

One object of the present invention is to prevent part of outgoing light emitted from a light emitter from reflecting in a specific direction, while blocking out part of the outgoing light, in a light source apparatus. The light source apparatus is provided with a light emitter that emits light; a reflector that reflects outgoing light emitted from the light emitter in a specific direction; and a light shield made from metal and disposed on a lateral side or at the back of the reflector. A plurality of concave portions or convex portions are formed at least in a partial area of the light shield.

### TECHNICAL FIELD

The present invention relates to a light source apparatus provided with a light shield that blocks out part of outgoing light emitted from a light emitter, and electronic equipment provided with the light source apparatus.

### BACKGROUND ART

Electronic equipment, such as a projection-type display apparatus, includes an enclosure that houses components, such as a light source apparatus. Since there is a strong demand for reductions in the size and weight of such a projection-type display apparatus, it is important to simplify components used to hold the light source apparatus and a display device. Accordingly, in view of these requirements, the use of resin components as components for light source apparatuses and display devices has been on the increase.

However, the problem with resin component is that they have lower heat resistance properties than metal components. Accordingly, a light shield made from a metal plate is provided in some cases, in order to protect these resin components against portions of light that are emitted from the light source apparatus and that advance in directions other than an intended direction (hereinafter referred to as unwanted light), and against heat generated by the radiation of the unwanted light.

If radiated onto the metal plate, the unwanted light reflects upon the metal plate. Part of this reflected light leaks out of gaps and openings in an enclosure and this part of light radiation strikes the low heat resistant resin components. In order to suppress the amount of such unwanted light leaking out of the enclosure and radiating the resin components, part of a light-shielding plate is painted black or a black tape is attached to part of the light shield. Consequently, it is possible to suppress the amount of unwanted light reflecting in a specific direction. However, the black paint and the black tape are liable to absorb the unwanted light and therefore cause the temperature of the light shield to rise. In addition, the black tape may fall off in some cases.

WO2009/031299A1, JP2006-285223A and JP2009-198627A disclose an antireflection structure which is made from a dielectric material and in which a plurality of pyramid-shaped convex portions or concave portions are laid out. The convex portions or concave portions of the antireflection structure disclosed in these literatures are disposed at a cycle (pitch) less than the wavelength of light. This structure greatly reduces the reflection of unwanted light incident on the antireflection structure, with the result that most of the unwanted light is either transmitted through the antireflection structure or is absorbed by the antireflection structure.

However, this antireflection structure is transmissive to light and therefore cannot block out light. If it is necessary to block out part of outgoing light, the antireflection structure is used together with a light shield. Adding such an antireflection structure causes an increase in the weight and cost of the apparatus. Accordingly, it is desirable to find another means for preventing part of the outgoing light from being reflected in a specific direction, while blocking out part of the outgoing light.

### CITATION LIST

### Patent Literature

Patent Literature 1: WO2009/031299A1

Patent Literature 2: JP2006-285223A

Patent Literature 3: JP2009-198627A

### SUMMARY OF INVENTION

A light source apparatus according to one exemplary embodiment of the present invention is provided with a light emitter that emits light; a reflector that reflects outgoing light emitted from the light emitter in a specific direction; and a light shield made from metal and disposed on a lateral side or at the back of the reflector. A plurality of concave portions or convex portions are formed at least in a partial area of the light shield. In addition, the present invention includes electronic equipment provided with the light source apparatus.

With the above-described light shield, it is possible to prevent one part of the outgoing light emitted from the light emitter from reflecting in a specific direction, while blocking out the part of the outgoing light.

### BRIEF DESCRIPTION OF DRAWINGS

FIG. 1 is a perspective view of a projection-type display apparatus.

FIG. 2 is a perspective view illustrating a light source apparatus disposed on the bottom plate of an enclosure.

FIG. 3 is a perspective view of the light source apparatus.

FIG. 4 is a perspective view of the light shield illustrated in FIG. 3.

FIG. 5 is an enlarged view taken by enlarging area A in FIG. 4.

FIG. 6 is a plan view illustrating a light shield in a first exemplary embodiment.

FIG. 7 is a schematic view of the light shield cut on the B-Bline of FIG. 6 taken from an oblique direction of the light shield.

FIG. 8 is a cross-sectional view of the light shield taken along the B-B line of FIG. 6.

FIG. 9 is a plan view illustrating a light shield in a second exemplary embodiment.

FIG. 10 is a plan view illustrating a light shield in a third exemplary embodiment.

FIG. 11 is a schematic view of the light shield cut on the C-Cline of FIG. 10 taken from an oblique direction of the light shield.

### DESCRIPTION OF EMBODIMENTS

Next, exemplary embodiments of the present invention will be described with reference to the accompanying drawings. In the following exemplary embodiments, the description will be made in detail by citing a projection-type display apparatus as an example of electronic equipment.

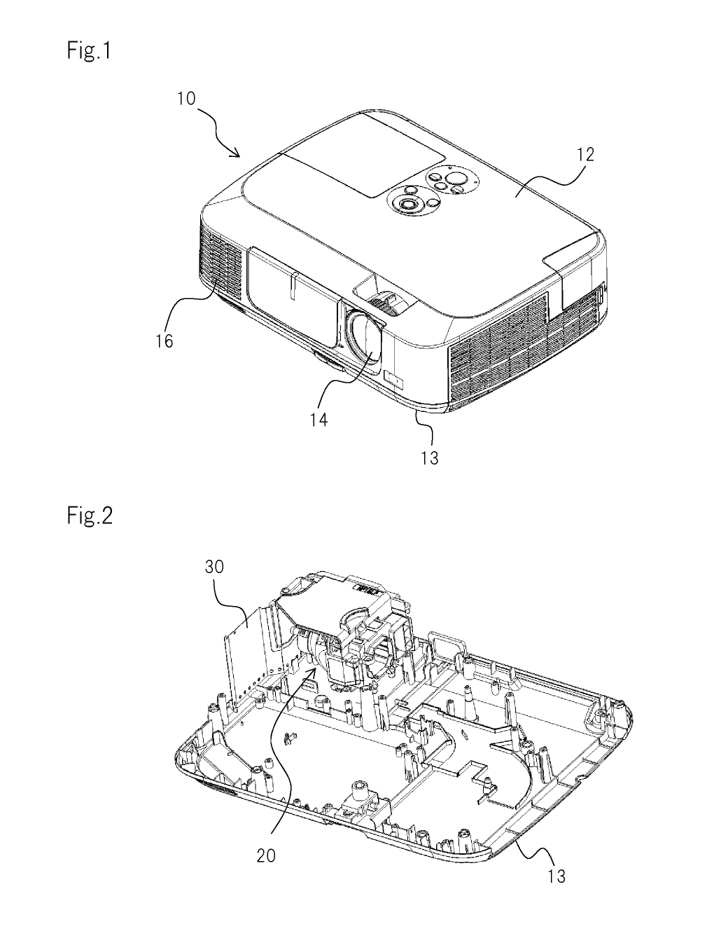

FIG. 1 is a perspective view of a projection-type display apparatus provided with a light source apparatus. Projection-type display apparatus 10 is provided with enclosure 12 that houses respective components; and projection lens 14 that projects image-forming light onto a screen. Exhaust openings 16 that release internal heat are formed in enclosure 12.

Light source apparatus 20, an optical engine that optically processes light emitted from light source apparatus 20, and the like are disposed inside enclosure 12. Light emitted from light source apparatus 20 is optically processed by optical components within the optical engine, and then projected onto a screen though projection lens 14.

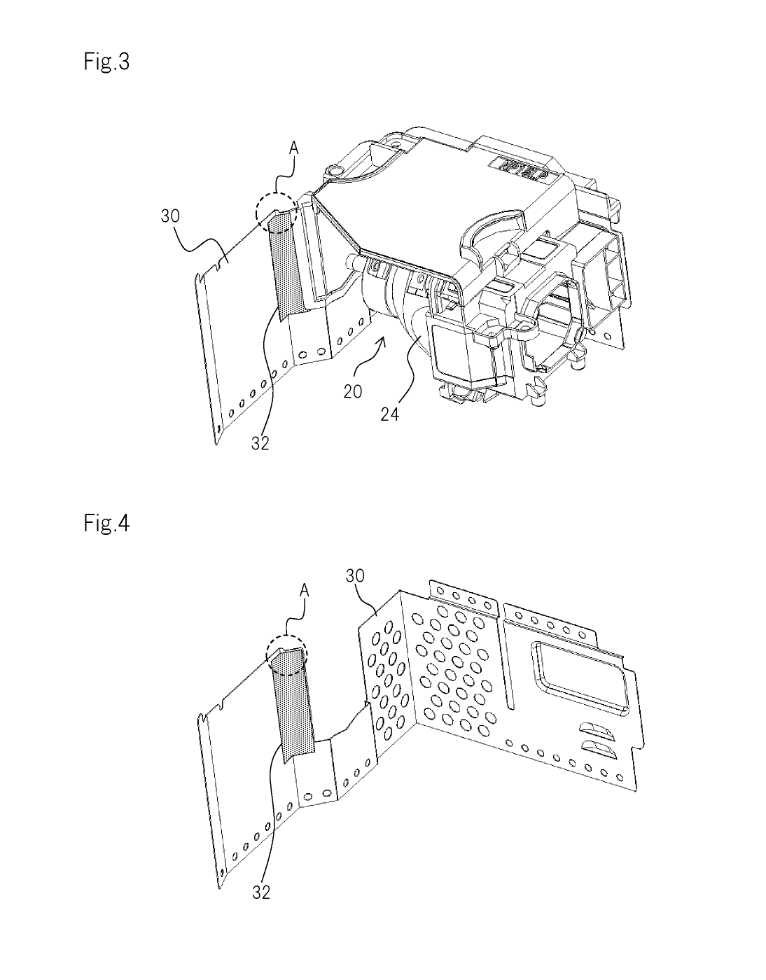

FIG. 2 illustrates light source apparatus 20 disposed on bottom plate 13 of enclosure 12, whereas FIG. 3 illustrates the configuration of light source apparatus 20. Light source apparatus 20 is provided with a light emitter that emits light; light shield 30 placed around the light emitter; and a lamp holder. The light emitter may be, for example, an ultrahigh-pressure mercury lamp. In addition, light source apparatus 20 is provided with reflector 24 that reflects light emitted from the light emitter (outgoing light) in a specific direction, for example, toward the optical engine. The inner surfaces of reflector 24 are mirror-finished. The lamp holder is a member that holds the light emitter.

Light shield 30 is disposed on a lateral side or at the back of the light emitter of light source apparatus 20. In the present exemplary embodiment, the light emitter is surrounded by reflector 24, and light shield 30 is disposed on a lateral side or at the back of this reflector 24. Light shield 30 may be located in any position, however, as long as the location requires light shielding.

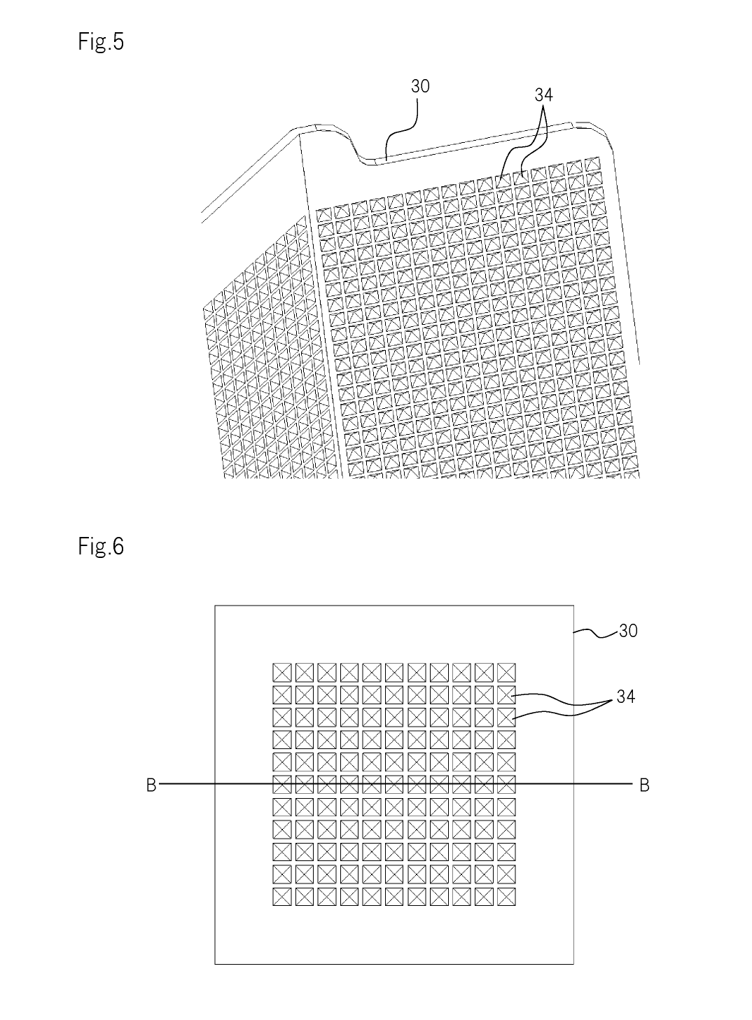

FIG. 4 illustrates light shield 30, whereas FIG. 5 is an enlarged view of area A in FIG. 4. Light shield 30 is made of metal and blocks out unwanted light produced in the light emitter. Here, unwanted light is part of outgoing light and refers to portions of light that are emitted from light source apparatus 20 and that advance in directions other than an intended direction, as described earlier. In the exemplary embodiment illustrated in FIG. 3, unwanted light is light that is emitted from the light emitter and that passes through gaps or the like between reflector 24 and the lamp holder. Light shield 30 is disposed in a location at which the unwanted light arrives.

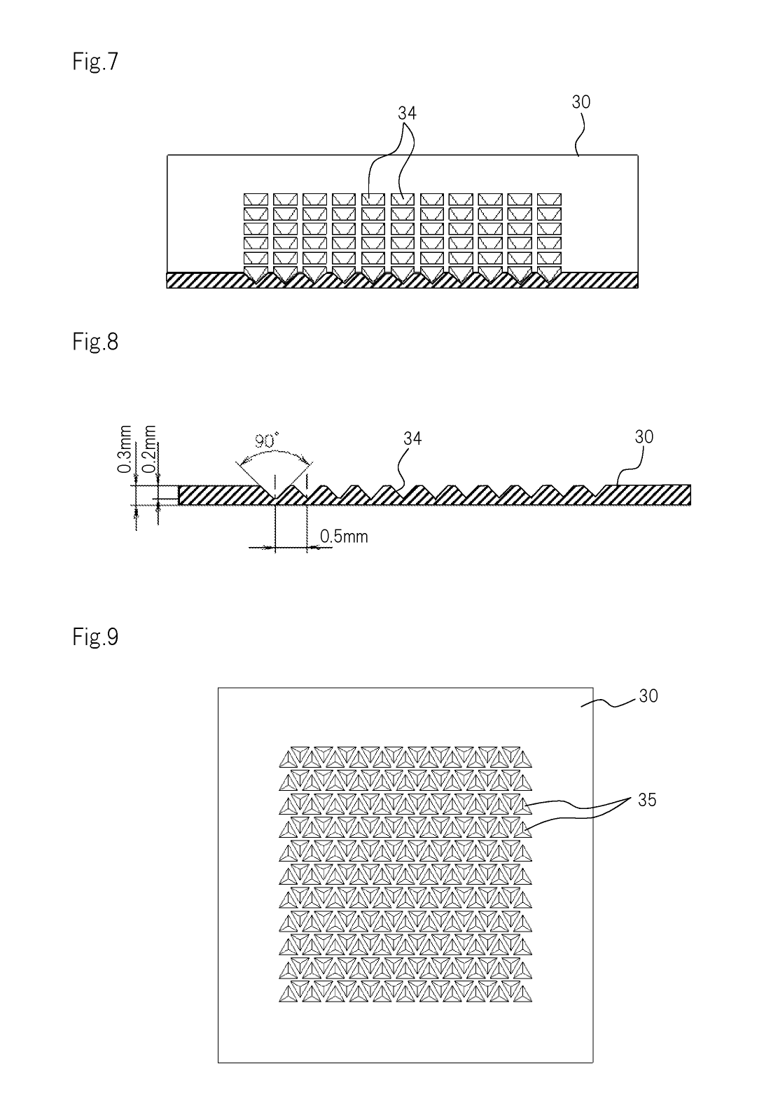

FIG. 6 is a plan view of light shield 30 in the first exemplary embodiment. FIG. 7 is a perspective view of light shield 30 cut along the B-Bline of FIG. 6 taken from an oblique direction of the light shield. FIG. 8 is a cross-sectional view of light shield 30 taken along the B-B line of FIG. 6.

A plurality of microstructural concave portions 34 are disposed at least in partial area 32 of light shield 30. These concave portions 34 are preferably laid out regularly into a matrix-like shape. In the present exemplary embodiment, each concave portion 34 is formed into an equilateral quadrangular pyramid shape. In this case, the plurality of concave portions 34 are preferably laid out into a tetragonal grid-like pattern, in order to densely arrange concave portions 34.

Light shield 30 reflects unwanted light which is part of outgoing light. If concave portions 34 are not formed, part of unwanted light reflected by light shield 30 strikes low heat resistant members or leaks out of exhaust openings 16 and the like of enclosure 12. Accordingly, it is desired to suppress the amount of unwanted light which radiates low-heat resistant members (hereinafter referred to as heat-generating light in some cases) and the amount of unwanted light which leaks out of the enclosure (hereinafter referred to as leakage light in some cases).

In light shield 30 illustrated in FIGS. 3 and 4, a plurality of concave portions 34 are formed on surfaces, among the surfaces of light shield 30, which can cause for such heat-generating light and leakage light. Specifically, the plurality of concave portions 34 are formed in a location which reflects unwanted light toward the low-heat resistant members unless concave portions 34 are formed. Examples of the low-heat resistant members include components, such as resin members, mounted inside enclosure 12. A plurality of concave portions 34 may also be formed in a location which reflects unwanted light toward exhaust openings 16 of enclosure 12 unless concave portions 34 are formed.

Light having arrived at the light shield from the light emitter of the light source apparatus reflects irregularly due to the presence of the plurality of concave portions 34. As a result, heat-generating light and leakage light are diffused and radiated to low-heat resistant members and exhaust openings 16, thus suppressing the amounts of light arriving at the low-heat resistance members and exhaust openings 16.

Area 32 where a plurality of concave portions 34 are formed is preferably formed only in part of light shield 30. Since unwanted light is radiated to area 32 where the plurality of concave portions 34 are formed, the area is a location where temperature is liable to rise. A location where the plurality of concave portions 34 are formed reflects light, rather than absorbs it. Concave portions 34 thus prevent light shield 30 from further generating heat. Accordingly, concave portions 34 may be provided on the entire surfaces of light shield 30.

Light shield 30 is preferably a metal plate formed from a metal material. In this case, it is possible to simultaneously form both light shield 30 by means of bending using a press die and concave portions 34 by means of shape transfer, such as stamping. As a result, the die is kept from becoming complex, thus allowing the light shield to be mass-produced at low cost. From the viewpoint of such metal processing, a surface of light shield 30 on the opposite side of the surface thereof including the plurality of concave portions 34 is preferably a planar surface. In other words, the plurality of concave portions 34 are preferably disposed only on one side of light shield 30.

Light source apparatus 20 that is used in projection-type display apparatus 10 generally includes a light shield made from metal. Forming a plurality of concave portions 34 in this light shield made from metal has the advantage of being able to suppress the amounts of leakage light and heat-generating light without having to add any new components.

Next, concave portions 34 will be described in detail. Each concave portion 34 preferably has a quadrangular pyramid shape the base of which is 0.4 mm in length, and the concave portions are preferably laid out at 0.5 mm pitches, as illustrated in FIG. 8. In the present exemplary embodiment, concave portions 34 are disposed in an area whose size is approximately half or more than half of a location where it is desirable that unwanted light be irregularly reflected. This way of configuration makes it possible to securely reflect unwanted light irregularly and suppress the amounts of light arriving at low-heat resistant members and exhaust openings 16. In the present exemplary embodiment, a plurality of concave portions 34 are laid out regularly with a flat portion present between concave portions 34. This flat portion may be or may not be present, however. That is, there only has to be a plurality of concave portions 34. In addition, the pitch is not limited to 0.5 mm For example, the pitch may be in the range of 0.2 mm to 1.2 mm The pitch has only to be sufficiently larger than the wavelength of unwanted light (infrared light) and may be, for example, equal to or greater than one hundred times the wavelength. In addition, the pitch may be 1.2 mm or smaller, in order not to lessen a diffuse reflection effect based on concave portions 34.

Yet additionally, an angle formed by a side on which concave portions 34 are formed and a lateral side of a pyramid that constitute each concave portion 34 is preferably 45°. The angle is not limited to 45°, however, but it may be in the range of, for example, 30° to 60°. If the angle is smaller than 30°, the lateral side of the pyramid approaches a vertical surface, whereas the lateral side of the pyramid approaches a flat surface if the angle is larger than 60°, thus lessening the diffuse reflection effect.

The depth of each concave portion 34 is preferably 0.2 mm The depth is not limited to 0.2 mm, however. The depth may be in the range of, for example, 0.05 mm to 0.25 mm. In this case, the plate thickness of light shield 30 is preferably 0.3 mm or so.

FIG. 9 illustrates light shield 30 in a second exemplary embodiment. In the second exemplary embodiment, concave portions 35 that are regularly laid out into a matrix-like shape are formed in light shield 30. Each concave portion 35 has an equilateral triangular pyramid shape. In this case, concave portions 34 that are different in orientation from each other are preferably arranged in an alternate manner, in order to densely dispose concave portions 34.

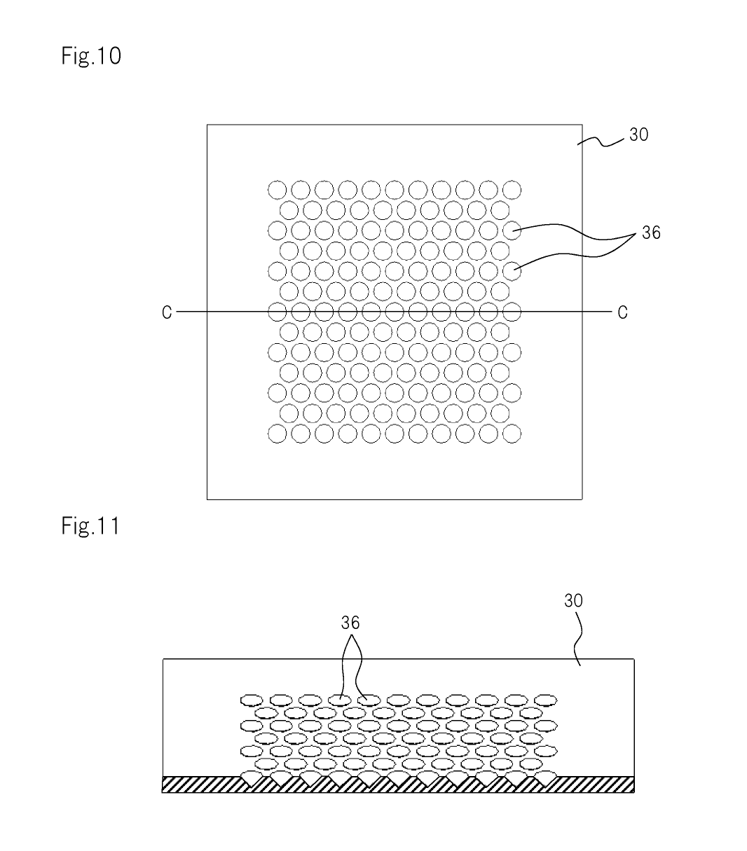

FIG. 10 illustrates light shield 30 in a third exemplary embodiment, whereas FIG. 11 is a schematic view of the light shield cut on the C-Cline of FIG. 10 taken from an oblique direction of the light shield. In the third exemplary embodiment, concave portions 36 regularly laid out into a matrix-like shape are formed in light shield 30. Each concave portion 36 has a conical shape. In this case, concave portions 36 are preferably arranged in a triangular grid-like pattern, in order to densely dispose concave portions 34.

In FIGS. 6 to 11, several preferred examples have been cited as the shapes of concave portions 34 to 36 formed in light shield 30. Without limitation to these shapes, however, the concave portions of the light shield may have any pyramidal or conical shapes. In addition, a plurality of microstructural convex portions may be formed in light shield 30. In this case, each convex portion preferably has a conical or pyramidal shape, more preferably an equilateral pyramidal shape. The range of pitches or sizes of each convex portion may be the same as the range of pitches or sizes of each concave portion.

Although in the above-described exemplary embodiments, light source apparatus 20 that is used in a projection-type display apparatus has been described in detail, light source apparatus 20 can also be used in any electronic equipment in addition to projection-type display apparatuses.

While preferred exemplary embodiments of the present invention have been presented and described in detail, it is to be understood that various changes and modifications may be made to the embodiments without departing from the gist or scope of the appended claims.

### REFERENCE SIGNS LIST

10: Projection-type display apparatus

12: Enclosure

13: Bottom plate

14: Projection lens

16: Exhaust opening

20: Light source apparatus

24: Reflector

30: Light shield

32: Microstructural area

34, 35, 36: Concave portion

1. A light source apparatus comprising:
a light emitter that emits light;
reflector that reflects outgoing light emitted from said light emitter in a specific direction; and
light shield that is made from metal and disposed on a lateral side and/or at the back of said reflector,
wherein a plurality of concave portions or convex portions are formed at least in a partial area of said light shield.

2. The light source apparatus according to claim 1, wherein the plurality of concave portions or convex portions are disposed at a pitch equal to or greater than one hundred times the wavelength of the outgoing light.

3. The light source apparatus according to claim 1, wherein the plurality of concave portions or convex portions are laid out regularly.

4. The light source apparatus according to claim 3, wherein the plurality of concave portions or convex portions have a pyramidal shape.

5. The light source apparatus according to claim 1, wherein a surface on the opposite side of a surface including the plurality of concave portions or convex portions comprises a planar surface.

6. The light source apparatus according to claim 1, wherein the plurality of concave portions or convex portions are formed in a location of said light shield which reflects part of the outgoing light toward low-heat resistant members.

7. Electronic equipment provided with a light source apparatus according to claim 1, the equipment comprising an enclosure that houses said light emitter and said light shield and includes an exhaust opening that releases internal heat, wherein the plurality of concave portions or convex portions are formed in a location of said light shield which reflects part of the outgoing light toward the exhaust opening.
